(19) United States
(12) Patent Application Publication
(10) Pub. No.: US 2015/0196008 A1
(43) Pub. Date: Jul. 16, 2015

(54) Anti-Pecking Spur

(71) Applicant: Thomas Prowell, Lafayette, CO (US)

(72) Inventor: Thomas Prowell, Lafayette, CO (US)

(21) Appl. No.: 14/592,327

(22) Filed: Jan. 8, 2015

Related U.S. Application Data
(60) Provisional application No. 61/964,653, filed on Jan. 10, 2014.

(51) Int. Cl. A01K 13/00; A01K 45/00

(52) U.S. Cl. CPC A01K 13/007; A01K 45/00

(57) ABSTRACT

An anti-pecking spur attaches to a bird to prevent other birds from pecking the wearer of the anti-pecking spur.

### CROSS-REFERENCE TO RELATED APPLICATIONS

This application claims the benefit of U.S. Provisional Application 61/964,653, filed Jan. 10, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of livestock implements. More particularly, the present invention is in the technical field of bird livestock implements.

Bird pecking continues to be a problem, particularly with game birds and poultry. Aggressive birds routinely target and attack other birds with their beaks. Birds, especially birds that are raised as poultry birds or livestock, face the threat of pecking from other aggressive birds. When livestock birds are pecked by other aggressive birds, they commonly lose portions of their feathers or suffer open sores. Other bird attachments designed to prevent pecking have succeeded to an extent, but otherwise limit the normal non-pecking activities of birds.

Known anti-pecking devices, particularly for poultry and game birds, such as the device described in U.S. Pat. No. 5,836,267A, feature an attachment to a bird's head or the beak area in order to limit said bird's ability to either see other birds clearly enough to peck, or utilize its beak to peck other birds. Some such devices restrict the ability of birds to use their eyes to see other birds. Other such devices restrict the ability of birds to use their beaks in an aggressive fashion with other birds.

Disadvantageously, this approach requires the limitation of the abilities of the birds wearing such devices to use their eyes or beaks for activities unrelated to pecking

### SUMMARY OF THE INVENTION

In an apparatus embodying the principles of the invention, a spur protruding from a bird's leg dissuades other birds from pecking. Pecking is defined as a bird using its beak to strike or bite something. Birds raised in a farm environment commonly are targeted for pecking by other aggressive birds.

At the heart of the present invention is the present inventor's discovery that when faced with a protruding attachment attached to or around the back-facing area of another bird, aggressive birds will refrain from their pecking activities.

In a preferred embodiment of the invention, then, an apparatus is affixed onto a bird's leg or foot 3, to cause other aggressive birds to refrain from pecking the bird that wears the apparatus. If desired, particular embodiments may optionally include streamers, string, ribbon, image depictions and/or other distracting materials 4 affixed to the main body of the apparatus near the point furthest away from the location where the apparatus is affixed to the bird 5.

This invention distracts and repels other birds that otherwise may peck the wearer of the apparatus without restricting the beak or vision related activities of the bird wearing the apparatus or the bird that would otherwise peck. Therefore, this anti-pecking invention substantially lowers reduction in birds' normal day-to-day non-pecking activities compared to birds wearing anti-pecking devices known in the prior art.

### BRIEF DESCRIPTION OF THE DRAWINGS

FIG. 1 is a perspective view of an apparatus embodying the principles of the present invention;

FIG. 2A is a different view of an apparatus embodying the principles of the present invention, also depicting the film covering an adhesive surface used to affix an embodiment of the present invention on to a bird;

FIG. 2B is a different view of an apparatus embodying the principles of the present invention, also depicting the adhesive surface re-adhering itself to the main body of an embodiment of the invention;

FIG. 3 is a different view of an apparatus embodying the principles of the present invention including distractors;

FIG. 4 is a different view of an apparatus embodying the principles of the present invention demonstrating a means to attach to a bird's leg;

FIG. 5 is a different view of an apparatus embodying the principles of the present invention demonstrating an alternative means to attach to a bird's leg;

FIG. 6 is a view of apparatuses embodying the principles of the present invention attached to a bird'a legs in a preferred manner of usage.

FIG. 7 is a different view of a different apparatus embodying the principles of the present invention demonstrating an alternative means to attach to a bird's leg;

### REFERENCE NUMERALS IN THE DRAWINGS

1 main body of the spur in the preferred embodiment

2 upward protrusion of spur in the preferred embodiment

3 mechanism to attach main body to a bird's leg in the preferred embodiment

4 distractors in the preferred embodiment

5 point opposite the location where the main body is attached to the leg of a bird in the preferred embodiment

6 serrated attachment mechanism in the preferred embodiment

7 adhesive mechanism in the preferred embodiment

### DETAILED DESCRIPTION OF THE INVENTION

The present invention relates to the field of the raising birds, including, as an example, chickens and pheasants. When birds are concentrated in large numbers in enclosed spaces, some birds are likely to peck other birds and to inflict wounds. The present invention is intended to prevent the birds wearing the said invention from being wounded by other birds' pecking activities.

The preferred embodiment of the invention addresses the problem of bird pecking without substantial interference in the common activities of birds wearing preferred embodiments of the invention. Unlike other known anti-pecking devices, the present invention does not itself result in substantial injury to the wearer. Moreover, unlike other known anti-pecking devices, the present invention is intended to avoid substantial interference with many of the activities of birds, including for example eating and laying eggs.

Among the anti-pecking devices known in the prior art are those depicted in include attachments to the head and beak of a bird and repellent sprays. Other known anti-pecking devices comprise an attachment to the beak of a bird to restrict the wearer's beak from effectively pecking other birds. Still other anti-pecking devices include blinders to prevent the wearer from seeing other target birds to peck. Such prior art devices, however, adversely impact the function of a bird's beak or eyes during non-pecking activities. For example, such prior art devices adversely impact the eating activities of a bird. Other known types of anti-pecking devices include bird repellent sprays. Such bird repellent sprays often irritate the wearer of such sprays. The present inventor has observed that bird repellent sprays limit the day-to-day non-pecking activities of birds in an unintended manner because of unintended irritation. Yet another known anti-pecking method involves the removal, alteration or mutilation of a bird's beak. Such removal, alteration or mutilation adversely impacts the quality of the bird's life. For instance, the removal of a bird's beak restricts such bird's ability to consume food. For a variety of reasons, the known anti-pecking devices typically inhibit the non-pecking day-to-day activities of birds while limiting the pecking activities. The devices and methods described in this paragraph and otherwise known in the prior art likely adversely impact the health, happiness and, ultimately, the commercial value of farm-raised birds.

As noted above, it remained for the present inventor to recognize that making anti-pecking devices that do not substantially inhibit many of the non-pecking activities of birds would provide numerous benefits, as detailed herein. The inventor's preferred embodiments of the present invention prevent pecking while not substantially inhibiting many of the non-pecking activities of birds.

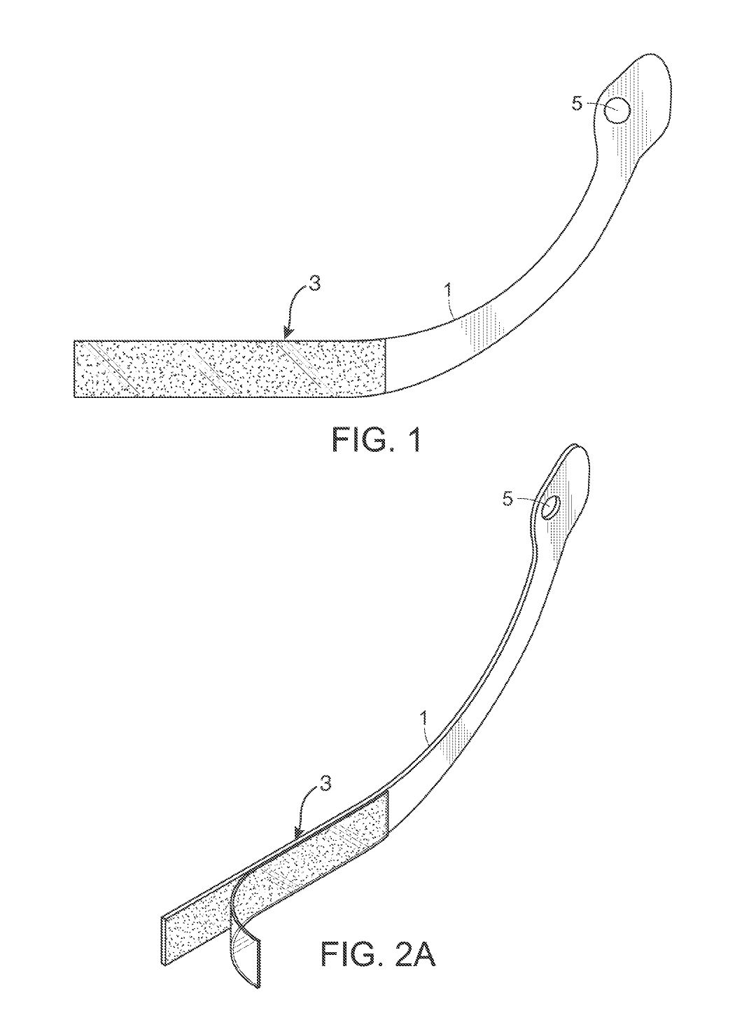

FIG. 1 depicts an embodiment of the present invention as an attachment to a bird's leg, or “anti-pecking spur,” or simply “spur.” This spur as depicted in FIG. 1, which represents a preferred embodiment of the present invention, dissuades other birds from pecking the wearer of said spur. At the same time, said spur does not limit the day-to-day activities of the wearer or otherwise adversely impact the health, happiness, and commercial value of the wearer of the spur, as compared to the anti-pecking devices known in the prior art.

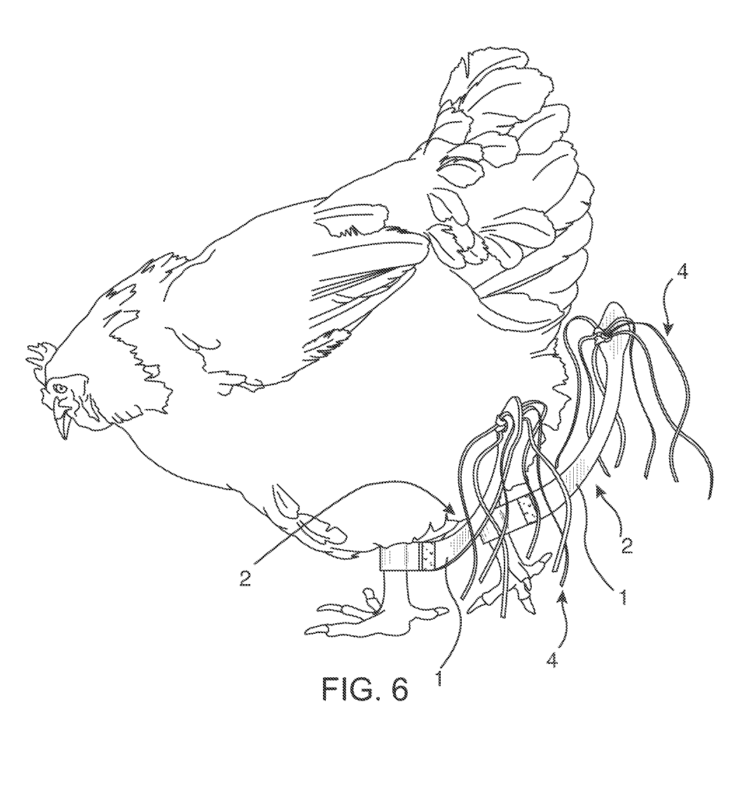

Preferred embodiments of the spur include a semi-rigid elongated mass intended to be attached to the hind or lower area of a bird, for example to a bird's leg or foot. In a preferred embodiment of the invention depicted in FIG. 1, the semi-rigid portion of the spur, hereinafter referred to as the “main body,” 1, is attached to the leg of a poultry bird via an attachment mechanism, 3, and protrudes rearward or sideward from a bird's leg or foot, as depicted in FIG. 6.

A preferred embodiment of the invention includes a main body, 1, which consists of a semi-rigid, flat material. The present inventor has discovered that said main body 1 can be made in a variety of lengths in a quite thin fashion, while maintaining its semi-rigid characteristics. A preferred embodiment of the invention is approximately two inches to twelve inches long from the end of the main body to the point where the spur affixes to the bird.

The present inventor has also discovered that the spur can be made in a lightweight fashion so that a variety of means may suffice to securely affix the main body to the bird's leg. A preferred embodiment of the invention includes a main body 1 that is composed of plastic. Other embodiments of the invention include a main body 1 that is composed of wood, cardboard or thick paper.

A preferred embodiment of the invention includes a main body 1 that protrudes roughly backward from a bird's leg and curves upward, as depicted in FIG. 6, 2. Other embodiments of the invention include a main body 1 that protrudes roughly straight backward or backward and then at a sharp angle upward from the bird. Still other embodiments of the invention include a main body 1 that protrudes sideway from the bird or sideway and backward.

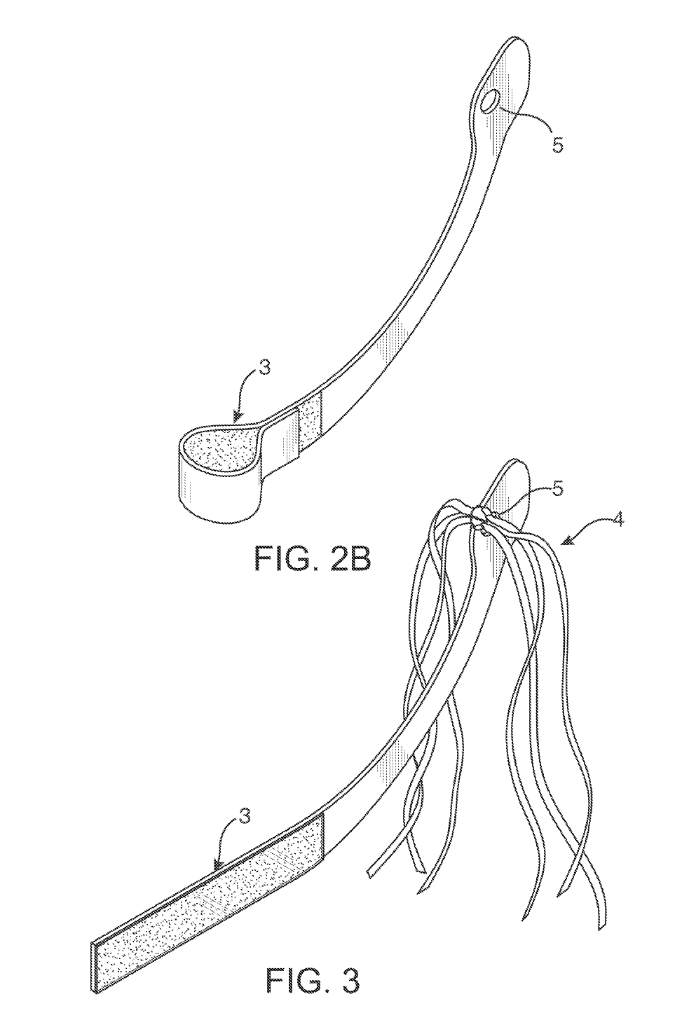

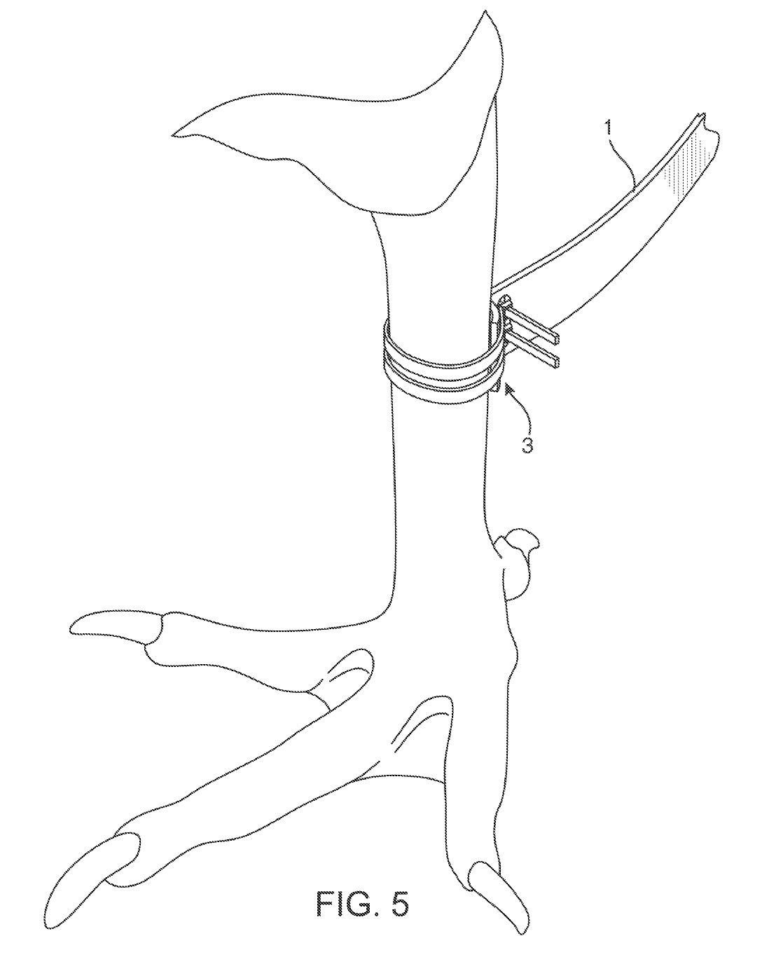

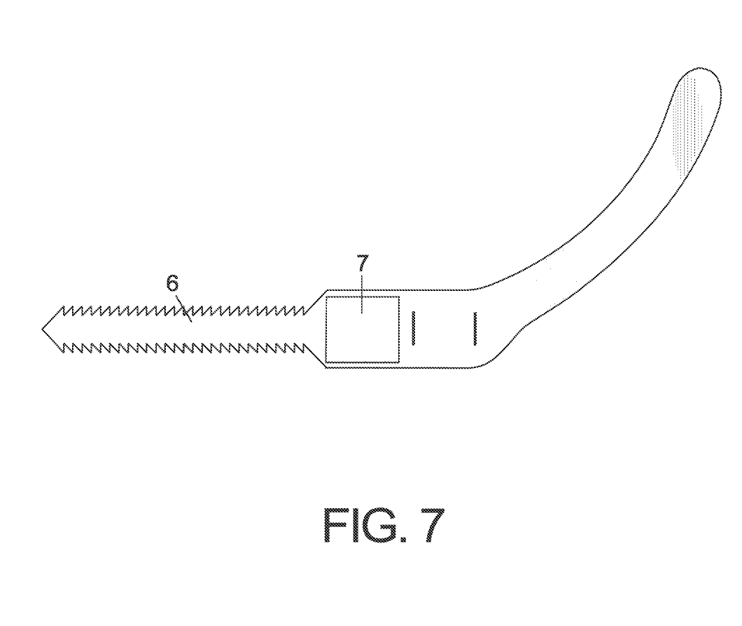

In embodiments of the invention, a variety of mechanisms may be utilized to attach the main body of the spur to the leg of a poultry bird, 3. In a preferred embodiment of the invention, depicted in FIG. 4, the inventor has found that adhesive tape, 3, functions particularly well when affixed to the main body, 1, and then wrapped around the leg of a bird. In a preferred embodiment of the invention, the attachment portion of the apparatus, 3, is composed of an adhesive tape with a removable covering to prevent the tape from sticking to unintended objects before placement onto a bird, as depicted in FIG. 2A. In a preferred embodiment of the invention, the tape curves around and then affixes itself to the main body, as depicted in FIG. 2B, 3. For instance, a preferred embodiment could include adhesive tape that curves around a bird's leg and then attaches to the main body, as depicted in FIG. 4. Other embodiments of the invention may utilize a zip-tie or zip-ties either glued to the end of the main body or threaded through holes cut into the main body 1, and then tightened around a bird's leg, as depicted in FIG. 5, 3. In other embodiments of the invention, the main body is attached to a bird's leg with string tied to the end of the leg. In other embodiments of the invention, the spur is attached to the bird by being glued or cemented directly on to the rear area or leg of a bird. In other embodiments of the invention, the spur is attached to a bird by a serrated singular protrusion, 6, as depicted in FIG. 7, intended to wrap around a bird's leg and then weave into a slot on or near the main body 1. An embodiment of the invention may also include an adhesive apparatus, such as the square of double sided tape depicted in FIG. 7, 7 intended to directly adhere said embodiment of the invention onto the leg of a bird.

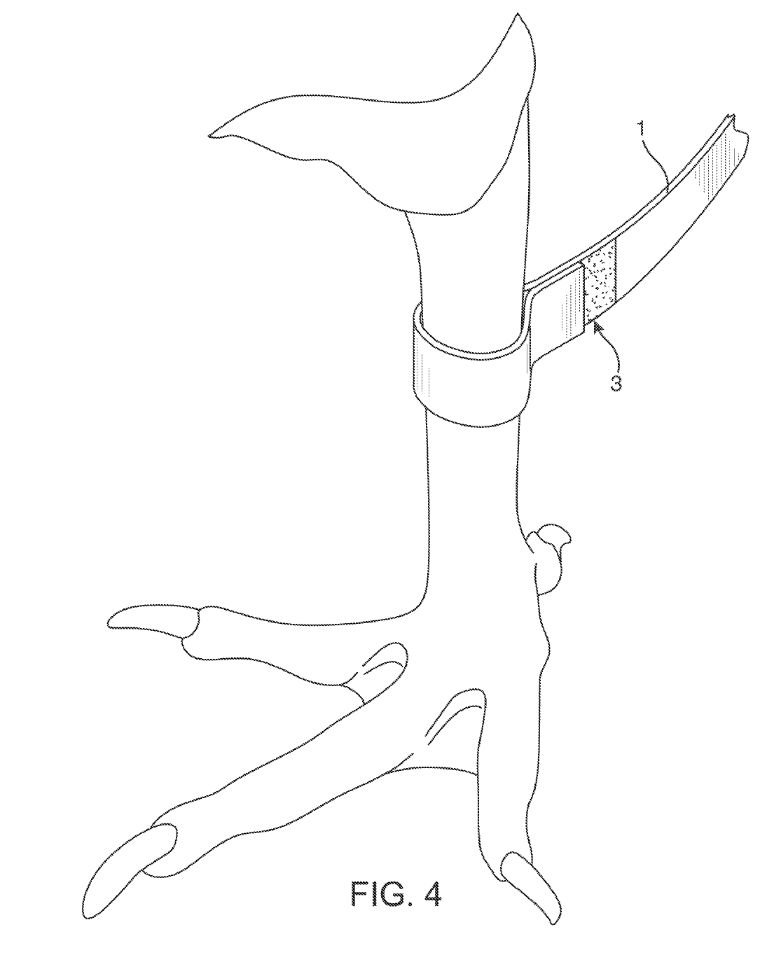

Preferred embodiments of the invention may include materials intended to distract, confuse or dissuade other pecking birds, hereinafter referred to and defined as “distractors,” 4, to aid in the function of dissuading other birds from pecking the wearer of the spur. Said distractors 4 may be affixed to the main body near the end of the main body opposite of the point where the main body is affixed to the bird, as depicted in FIG. 3, 5. Preferred embodiments of the invention may include distractors 4 composed and/or comprising of a variety of materials, including, but not limited to, ribbons, streamers, pipe cleaners, pom-poms, tinsel, feathers, fur balls, feather boas, strings, fabrics and/or other similar items. The present inventor has observed that the distractors 4 cause confusion in birds that might otherwise peck the wearer of a preferred embodiment of the invention. In a preferred embodiment of the invention, depicted in FIG. 2B, distractors, 4, are threaded through a hole near the end of the main body farthest away from the attachment point of the main body to the bird's leg and then tied, 5. Distractors 4 of a variety of shapes and colors may be affixed to the main body in preferred embodiments of the invention. Other embodiments of the invention include materials depicting two dimensional or three dimensional shapes, especially such as eyes or other depictions of objects perceived by birds to be threatening.

A spur embodying the principles of the invention can be used alone or in tandem with another spur or spurs affixed to the same leg or neighboring bird legs. For example, a bird may have an injured leg, but may benefit from wearing the spur on the other non-injured leg. The present inventor has observed that a preferred embodiment of the invention demonstrates the greatest effectiveness when at least one spur is affixed to each and every of a bird's legs, as depicted in FIG. 6.

The preceding description has been presented with reference to various embodiments. Persons skilled in the art and technology to which this application pertains will appreciate that alterations and changes in the described structures and methods of operation can be practiced without meaningfully departing from the principle, spirit and scope.

The present systems, methods, means, and enablement are not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

I claim:

1. An apparatus comprising an anti-pecking spur.

2. The apparatus of claim 1, further comprising a mechanism for attaching the main body of the apparatus to a bird.

3. The apparatus of claim 1, further comprising distractors that affix to the main body of the apparatus.

4. The apparatus of claim 1 further comprising a plastic main body.

5. The apparatus of claim 1, further comprising fabric distractors.

6. The apparatus of claim 1, further comprising plastic ribbon distractors.

7. The apparatus of claim 5, wherein the main body of the apparatus protrudes away from the bird to which the apparatus is attached with an upward trajectory.

8. An apparatus comprising a spur for dissuading other birds from pecking its wearer.

9. An anti-pecking spur, consisting of an attachment mechanism, distractors, a plastic main body, wherein said plastic main body protrudes upward and away from the bird wearer of said anti-pecking spur.
